(19) United States
(12) Patent Application Publication
(10) Pub. No.: US 2012/0269958 A1
(43) Pub. Date: Oct. 25, 2012

(54) MATERIAL BUILDUP SIMULATIONS BY APPLICATION OF POWDER JET MASS CONSERVATION PRICIPLES

(76) Inventors: Ramesh Subramanian, Oviedo, FL (US); Alexandr Sadovoy, Berlin (DE)

(21) Appl. No.: 13/503,715

(22) PCT Filed: Feb. 16, 2010
(86) PCT No.: PCT/US10/24260

§ 371 Date: Jul. 13, 2012

Related U.S. Application Data
(60) Provisional application No. 61/255,199, filed on Oct. 27, 2009.
(60) Provisional application No. 61/261,811, filed on Nov. 17, 2009.

(51) Int. Cl. B05D 1/02; B05D 3/06; B05D 1/08

(52) U.S. Cl. 427/9; 427/446; 427/457; 427/580

(57) ABSTRACT

A method for simulating of the thickness of a coating which is placed onto a substrate surface is disclosed. The thickness is simulated using mass conservation principles. In a preferred embodiment at least one reference spray trial is performed, the correlation of a single spray profile to at least one spray process parameter is determined, the single spray profile is simulated using mass conservation principles to an incoming powder jet stream.

### CROSS REFERENCE TO RELATED APPLICATIONS

This application is the US National Stage of International Application No. PCT/US2010/024260, filed Feb. 16, 2010 and claims the benefit thereof. The International Application claims the benefits of U.S. application No. 61/255,199 filed Oct. 27, 2009 and U.S. application No. 61/261,811 filed Nov. 17, 2009. All of the applications are incorporated by reference herein in their entirety.

### FIELD OF INVENTION

The present invention relates to a method for simulating of the thickness of a coating which is placed, for example sprayed, onto a substrate surface.

### BACKGROUND OF INVENTION

In U.S. Pat. No. 6,256,597 B1 a spray coating simulation for a robotic spray gun assembly is disclosed, which imports a discretized model of an object geometry. The simulator imports a numerically characterized spray pattern file and a robot motion file having a plurality of motion positions, dwell times and orientations defining a motion path of the spray gun. The individual motion positions within the motion file are read and a determination is made as to which portions of the object geometry are visible at each motion position. A coating thickness at each visible portion of the object geometry is computed, based on the specified spray pattern data, the dwell time and the orientation of the robot motion path, for each motion position. Finally, the total coating thickness over the object geometry is calculated.

Theoretical investigation of thermal spraying divides the spray process into sub-processes, which are by itself enough complex and are mainly simulated with different numerical methods. The equations of mass and thermal interactions of the plasma or flame jet with molten powder particles are solved numerically applying finite elements method in frames of computational fluid dynamics The heat transfer from the plasma jet and powder particles to the substrate has to be taken into account and simulated in frames of thermodynamics (see Hurevich V, Gusarov A, Smurov I, Simulation of coating profile under plasma spraying conditions, Saint Etienne/France).

The thermo-mechanical problem of the single splat formation on the substrate surface, building of the entire coating, its bonding and adhesion with the substrate needs also sophisticated numerical analysis. Due to the numerical complexity of the mentioned problems a large amount of the initial parameters need to be taken into account. Up to now, there is no complete full scale, self consistent theoretical simulation model of the coating process.

Two known models which give a complete possibility to simulate resulting coating properties for the production conditions are developed by Alstom and independently by GE (see U.S. Pat. No. 6,256,597 B1 and Numerical Calculation of the Process Parameters, which Optimise the Gas Turbine Blade Coating Process by Thermal Spraying, for given Spray Paths, Dr. Martin Balliel, COST 526—Project CH2 Final Report (ALSTOM)). In frames of these models it is possible to simulate a thickness of the resulting coating. These models use data tables with experimental results for the spray profile or static spray spot obtained in the experiments carried out in some range of process parameters. Further approximation and extrapolation of this data is used for the simulation of the spray process with varying process parameters. Such an approximation has several disadvantages. It requires a lot of experiments to gain the needed accuracy (bulky data input). It can not be safely used outside the approximation parameters range (limited parameter range). All the correlation coefficients need to be recalculated and/or test experiments need to be repeated, if some even small changes in the process parameters take place (poor transferability). Furthermore, some important for the simulation accuracy features such as an asymmetry of the spray profile in respect to the motion direction and spray angle variations can not be exactly described.

### SUMMARY OF INVENTION

It is the objective of the present invention to provide an advantageous method for simulating of the thickness of a coating which is placed onto a substrate surface.

This objective is solved by a method for simulating of the thickness of a coating which is placed onto a substrate surface as claimed in the claims. The depending claims define further developments of the invention.

In the inventive method for simulating of the thickness of a coating, which is placed onto a substrate surface, the thickness is simulated using mass conservation principles. Especially, the thickness distribution may be simulated using mass conservation principles. Preferably, the coating may be sprayed onto the substrate surface.

A physical model of coating deposition for a separate single spray profile can be created and the simulation parameters can be set. A thickness equation for the spray spot and the spray profile using mass conservation law can be obtained. Experimental trials can be performed for gaining input simulation parameters for the concrete spray process. A test program for spraying of horizontal, vertical and for validation tilted profiles can be carried out with nominal parameters. The parameters of the coating thickness distribution in the reference profile sprayed with the nominal process parameters can be obtained in this reference test. This parameters can be input into the model formula for the thickness distribution in the separate spray profile, based on the physical simulation model of thermal spray. This formula describes a semi Gaussian thickness distribution in the separate spray profile depending on the variation of the process parameters. This formula can be implemented into commercial robotic simulation software (for example Robcad from Siemens PLM). The resulting thickness distribution for a robotic path represents a superposition of thicknesses of the separate spray profiles. The simulation software may compute the separate spray profiles and perform the thickness superposition.

The invention overcomes the disadvantages described above and provides a robust simulation approach to materials buildup based on mass conservation of the deposited material. The inventive method improves designing and visualisation of of coating robotic path on PC and avoids a cut up of qualification components. The inventive coating simulation enables to investigate a priori the resulting coating thickness distribution. This allows to improve the robotic path without additional booth trials and metallographic inspections and enabbles a semi-virtual production.

The coating may be sprayed onto a gas turbine component, for example onto a turbine blade and/or a turbine vane. The coating may be sprayed onto a surface using thermal spray coating deposition.

Mass conservation principles may especially be applied to powder jet deposition for a simulation model of materials build-up. This enables a full scale, self consistent and transferable physical simulation model, for example for thermal spray coating deposition processes. Generally, the substrate surface may be coated by atmospheric plasma spraying (APS), high velocity oxygen fuel spraying (HVOF), low pressure plasma spraying (LPPS), thermal spray coating deposition, laser cladding, wire arc spraying, cold spraying, sensor deposition or generic painting.

Advantageously, an incoming powder jet may be simulated as a conical fan expanding with distance from a nozzle. Moreover, the thickness can be simulated using mass conservation laws inside a powder jet accelerated from the nozzle to the substrate surface. The powder jet may be a molten powder jet.

The inventive method may comprise the following steps: At least one reference spray trial may be performed. The correlation of a separate spray profile to at least one spray process parameter, preferably to a nominal process parameters set, may be determined. The model formula based on the mass conservation laws for the thickness distribution in a separate spray profile depending on the spray parameters variations may be obtained. The separate spray profile is a result of the linear motion of the spray gun. It represents a building block of a typical coating program. The resulting thickness distribution may result in the superposition of the separate spray profiles applied with the spray gun onto the substrate surface with a definite geometry.

Advantageously, the correlation of a single spray profile to at least one deposition variable may be determined. Experimental input from the spray trial as reference experiment regarding the nominal spray profile and use of the model function which takes into account the deposition variables, like spray gun angle, distance, speed, powder feed rate, spray efficiency etc., allows for building a complete, self consistent and accurate simulation model. From the spray trials, experimental data help to establish correlation coefficients of the mass conservation model, used for the deposition process. This modeling approach also enables spray/deposition efficiency calculation.

For example, the correlation of the single spray profile to a powder feed rate and/or the correlation of the single spray profile to a flux density and/or the correlation of the single spray profile to the distance between a spray gun and the substrate surface and/or the correlation of the single spray profile to a spray gun speed and/or the correlation of the single spray profile to a spray angle and/or the correlation of the single spray profile to the spray efficiency can be determined.

Moreover, the correlation of the single spray profile to a thickness standard deviation, especially thickness standard deviations referenced to a Gaussian distribution model, and/or the correlation of the single spray profile to a standard deviation of flux density and/or the correlation of the single spray profile to a standard deviation of the thickness distribution of the single spray profile and/or the correlation of the single spray profile to the coating density and/or the correlation of the single spray profile to the displacement of the single spray profile from a tool central point can be determined.

The simulation of the thickness of the coating or the coating spray pattern can be based on modeling of a single spray spot/profile, using mass conservation principles to an incoming powder jet stream. The spray profile is a result of the linear motion of the single spray spot/profile on the surface, for example according to the motion of a spray gun. The spray profile represents a building block of any coating program. Thus, an overlapping of the single spray profiles, displaced by some offset distance results in a spray pattern on the substrate surface. Modeling based on mass conservation principles of the spray profile can be based on the dependence on spray process parameters and enables realistic simulation of complicated spray patterns. This method is applicable for complex geometry turbine components, especially gas turbine components.

Preferably an efficiency factor may be determined Moreover, the dependence of the efficiency factor on a spray angle can be determined. Furthermore, the dependence of a standard deviation on a spray distance and/or the dependence of a standard deviation, preferably a Gaussian standard deviation, on a spray gun tilting angle may be determined.

Generally the normal component distribution of the power speed of the powder jet and/or the normal component distribution of the power density of the powder jet and/or the normal component distribution of a resulting mass flux density of the powder jet can be considered to fit Gaussian law in any cross section of the powder jet. For example, the single spray profile thickness distribution can be considered to have a Gaussian distribution in the direction perpendicular to a substrate cross section and/or to have an elliptical form in the projection onto the substrate surface. The single spray profile especially may be considered to have an elliptical thickness distribution for a fixed tool central point (TCP). The corresponding thickness distribution in the single spray spot sprayed from the fixed position of the spray gun TCP (tool central point) can be considered to have a Gaussian distribution in a perpendicular to the substrate cross section and to have an elliptical form in the projection onto the substrate surface. The corresponding single spray profile thickness distribution obtained by the linear motion of the spray gun TCP can be considered to have a corresponding Gaussian distribution in the cross section perpendicular to a substrate and to the direction of motion.

Conservation and transfer laws may be considered for the powder mass intersecting a substrate layer of the jet. An equation for the deposition coating thickness distribution may be defined. Advantageously, the equation can based on considered conservation and transfer laws for the powder mass intersecting a substrate layer of the jet.

Single spray profiles from a number of injection sprayings can be represented as a sum of a number of single spray profiles. A spray profile from a the multiply injector spraying can be represented as a sum of a corresponding number of single spray profiles. The corresponding number of single spray profiles can be displaced on certain distances.

The coating thickness may be calculated analytically for a given coating pattern, for example for a given spray pattern.

The inventive method is widely applicable. Non approximate physical character of the spray profile modeling avoids carrying out a lot of experimental trials to gain initial data for the spray profile. On the other hand experimental input from the reference test of some complex process properties such as spray efficiency and standard deviations, for example Gaussian standard deviations, of thickness in the spray profile makes the model not too complex for practical implementation. This compromise and combination of theoretical background and empirical input allow building an exact, self consistent and useful in practice simulation procedure.

The inventive method uses as input only process parameters such as powder feed rate, spray distance, gun speed and spray angle. Other process properties such as spray efficiency, thickness standard deviations, coating density and possibly displacement of the spray spot from the tool central point (TCP) can also be incorporated in the model using the experimental data from the reference test. The selected input process parameters can be changed easily based on specific spray booth setup parameters. This enables an easy adaptation of the simulation during deposition process development and can be naturally implemented in the simulation model.

The inventive method provides an easy transferable and extendable model. The model includes generic features of the spray processes what makes it easily transferable for different coating units of the same or similar type. This generic character lets also to build in the simulation model for the new spray processes in a short time. For example simulation of spray with double and multiply injectors is naturally incorporated in the model.

The final equation for the coating thickness distribution in the spray profile and the procedure of simulation parameters setting have the form useful for implementation into the painting simulation modules of commercial robotic simulation software.

### BRIEF DESCRIPTION OF THE DRAWINGS

Further features, properties and advantages of the present invention will become clear from the following description of an embodiment in conjunction with the accompanying drawings. All mentioned features are advantageous alone and in any combination with each other.

FIG. 1 schematically shows the process geometry.

FIG. 2 schematically shows liquid/solution precursor plasma spraying.

FIG. 3 schematically shows suspension plasma spraying.

FIG. 4 schematically shows a powder injection into a flame.

FIG. 5 schematically shows a solid wire injection into plasma.

FIG. 6 schematically shows a cold spray process.

FIG. 7 schematically shows a powder injection into laser.

FIG. 8 schematically shows a single spray profile.

FIG. 9 schematically shows a double spray profile.

### DETAILED DESCRIPTION OF INVENTION

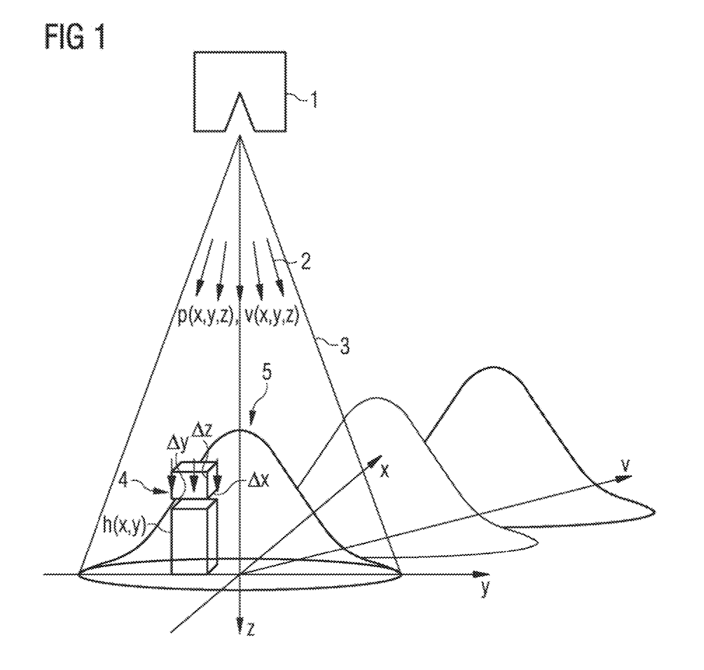

An embodiment of the present invention will now be described with reference to FIGS. 1 to 7. FIG. 1 schematically shows the process geometry. A spray gun 1 is used to spray a material jet 2 in direction z onto a surface. The surface is placed in the x,y-plane. The material jet 2 has the form of a conical fan 3. The coating deposited on the surface has a thickness distribution, which is referred here as height h(x,y), and comprises a number of volume elements, which are referred here as jet elements 4 (ΔxΔyΔz). The the thickness distribution h(x,y) in a spray spot 5 defines the thickness distribution of the spray profile obtained with the linear movement of the spray gun.

The dependence of the single spray profile on process parameters, for example the correlation of the single spray profile to at least one deposition variable, preferably a nominal spray parameters set, is determined by performing a reference spray trial. For instance, the correlation of the single spray profile to the powder feed rate and/or to the flux density and/or to the distance between the spray gun and the substrate surface and/or to the spray gun speed and/or to the spray angle and/or to the spray efficiency and/or to the thickness standard deviation and/or to the standard deviation of flux density and/or to the standard deviation of the thickness distribution of the single spray profile and/or to the coating density and/or to the displacement of the single spray profile from the tool central point is determined. Moreover, the efficiency factor and/or the dependence of the efficiency factor on the spray angle and/or the dependence of the standard deviation on the spray distance and/or the dependence of the standard deviation on the spray gun tilting angle is determined.

The single spray profile is simulated using mass conservation principles to the incoming powder jet stream 2. The spray gun 1 is moved along a moving direction 6. The spray profile is simulated based on an assumptopn of a linear motion of the spray gun 1.

At least one final equation representing the thickness distribution of the spray profile is formed and the resulting thickness distribution of the coating is simulated based on the single spray profile.

The inventive method is based on mass conservation laws inside the powder jet 2, for example a molten powder jet, accelerated from the nozzle 1 to the deposition surface. The jet 2 is simulated as a conical fan 3 expanding with distance from the spray nozzle 1. It is considered, that the normal component distributions of the powder speed v_{z}, the powder density ρ and the resulting mass flux density ρν_{z} fit the Gaussian law in any cross section of the jet 2. Consideration of the conservation and transfer laws for the powder mass intersecting the substrate layer of the jet 2 enables the definition of an equation for the deposition coatings thickness distribution.

For a fixed tool central point (TCP) position of the spray gun 1, a typical coating has a Gaussian mountain-like thickness distribution, reflecting the Gaussian distribution of the powder flux density in the jet 1. In addition, the relation between unknown flux density ρν_{z}, powder feed rate \dot{M} and standard deviations of the flux density and spot thickness distribution σₓ and σ_{y} will also be obtained. If the standard deviations are not equal the spot is asymmetrical and has an elliptical form. These standard deviations are obtained experimentally in the reference experiment. The powder loss during the deposition onto the substrate surface will be introduced in the model with the efficiency factor A, which is known for the particular deposition process. This too is obtained in the reference experiment.

Assuming a conical form 3 of the spray jet 2 and considering geometrical relations, the dependence of the standard deviations σₓ and σ_{y} on spray distance and gun tilting angles can be incorporated in the final equations for the spray spot thickness distribution.

In general the single spray spot has a Gaussian thickness distribution in a perpendicular to the substrate cross section and an elliptical form in the projection onto the substrate surface. The parameters of the spray spot depend on such known process parameters as feed rate \dot{M}, spray distance d, spray angles β and a spray time. The unknown parameters of the model are the standard deviations σₓ and σ_{y} of the spray spot and the spray efficiency A, representing additional process parameters, which can be measured in the reference experiment.

The spray spots from double and multiple injection sprayings can be represented as a sum of two or multiple spots, corresponding to the displaced powder injectors. A time integration of the spray spot thickness distribution taking into account the gun speed dependence results in a thickness distribution in the corresponding spray profile. Analytical solutions are possible for a coating thickness distribution in a linear spray profile, created with the linear movement of the spray gun. For complicated non linear motion numerical methods can be applied.

Superposition of the coating thicknesses of several spray profiles results in a thickness distribution for a given spray pattern. The typical coating programs represent a raster movement of the spray gun with parallel aligned spray profiles displaced on some distance (path offset p). In this case the resulting coating thickness of the spray layer can be calculated analytically.

Current spray programs to coat the turbine components utilize several layers. Here the starting tool central point position of the next layer can be displaced with respect to the previous layer (layer offset l). Such structures could be also described in frames of this model as a superposition of the multiply spray profiles with displaced tool central point positions.

To characterize the spray process and to validate the model simulations, an input of the spray efficiency A and standard deviations σₓ and σ_{y} is necessary. In this experiment, a metal plate thick enough to avoid a thermal distortion during spraying can be used. To obtain a representative result of the spray efficiency, the plate can be sufficiently treated for the particular process. Two perpendicular spray profiles through the middle are applied. Thus a “cross” spray pattern appears on the surface of the plate.

The one-dimensional thickness distribution of the both spray profiles will be measured perpendicular to the profile length at three positions with tactile or optical scanning technique. Resulting empirical thickness distribution can be statistical treated and an average distribution curve can be Gaussian fitted.

Analysing the fitting curve the maximum thickness values, standard deviations σₓ and σ_{y} and displacements Δx_{d} and Δy_{d} from the tool central point for each spray profile can be calculated. Empirical area under the profile curve of each of the spray profile may be compared with the theoretical values of the corresponding profile at 100% efficiency. The averaged value for the resulting ratio of both profiles gives a value for the spray efficiency.

An alternative and less cost and time consuming method to measure the spray efficiency A is to spray a raster spray pattern onto the metal plate and to weight the plate before and after spraying. The ratio between measured weight difference and theoretical simulated value gives spray efficiency. In this manner a dependence of the spray efficiency on the on the spray angle can be studied.

To measure the parameters for the double and multiple injections only one injector can be used in the experiments. The results for the other injector seem to be the same and can be calculated using geometrical considerations.

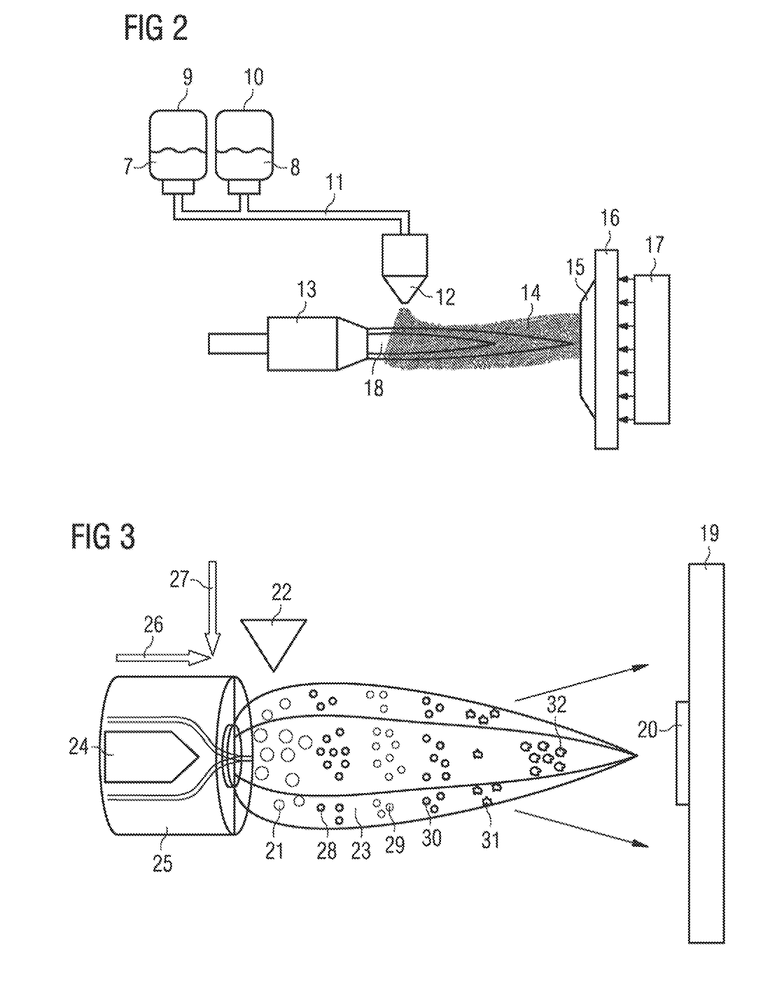

In conjunction with FIGS. 2 to 7 examples for different coating methods are explained. The inventive method can be applied to these coating methods. Of course, further coating methods are possible.

FIG. 2 schematically shows liquid/solution precursor plasma spraying. A first solution precursor 7 and/or a second solution precursor 8, which are stored in precursor stores 9 and 10, are lead to a liquid injector 12 via a fluid channel 11. By means of the liquid injector 12 droplets 14 of the first precursor 7 and/or the second precursor 8 are injected into a plasma 18 coming from a plasma spray nozzle 13. The plasma 18 and the solution precursor 7, 8 are sprayed onto a surface of a substrate 16 forming a coating 15. The temperature of the substrate 16 is controlled by means of a temperature control unit 17.

FIG. 3 schematically shows suspension plasma spraying. A suspension 21 is injected into a plasma jet 23. The plasma jet 23 is generated by means of an anode 24 and a cathode 25. The plasma jet 23 is sprayed in axial direction 26. The suspension particles 21 are injected into a plasma jet 23 in transverse direction 27. After exploding of the suspension particles 28, a solvent evaporation 29, followed by an oxide formation 30, a partial melting 31 and a full melting 32 takes place before the fully molten particles 32 arrive at a surface of a substrate 19 where they form an adherent coating 20.

In the framework of solution and suspension plasma spraying deposition of thermal barrier coatings with solution and suspension plasma spraying can also be modeled. Liquid carriers of materials, either as an inorganic solution or a fine suspension, can modeled based on mass transfer principles. The deposited thickness and deposition efficiency can be modeled based on the spray profile generated by the deposition process, using mass conservation principles.

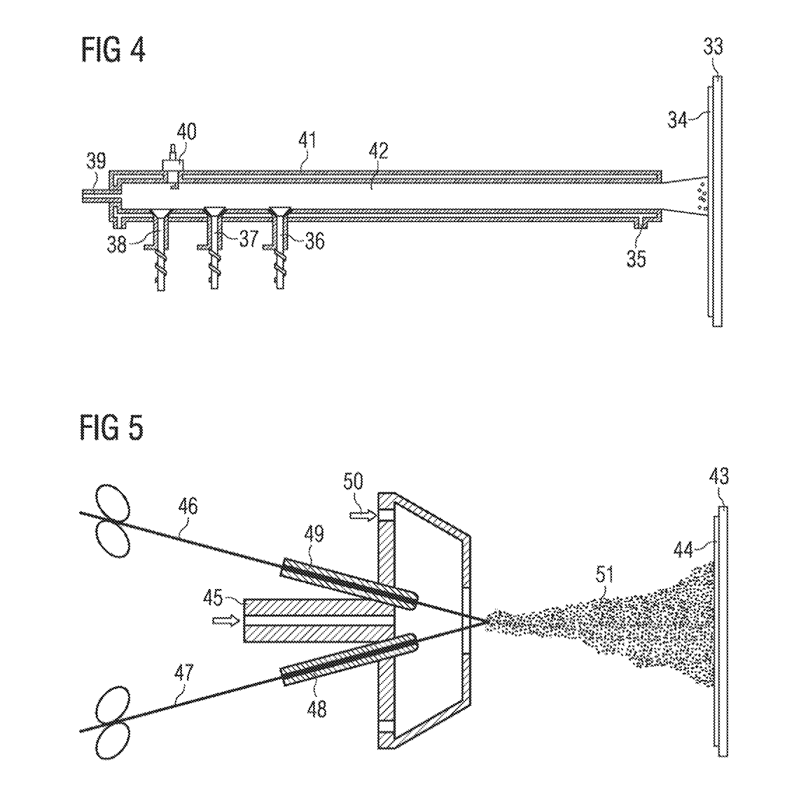

FIG. 4 schematically shows a powder injection into a flame. A coating 34 is placed onto a surface of a substrate 33 by means of a flame 42. The flame 42 is generated inside of a flame pipe 41. The flame pipe 41 comprises a spark plug 40, a powder inlet 39, a nitrogen purge 38, a fuel gas inlet 37, an oxygen inlet 36 and a cooling water inlet 35.

FIG. 5 schematically shows a solid wire injection into plasma. Two solid wires 46, 47 are injected via contact tubes 48, 49 into a plasma comprising primary atomized air coming from a nozzle 45. Secondary air 50 is added and a spray stream of molten atomised particles 51 is formed. The spray stream 51 generates a coating 44 at a surface of a substrate 43. Depending upon the wire feed rate and the corresponding spray profile build up, the inventive method can be adapted to coating thickness buildup.

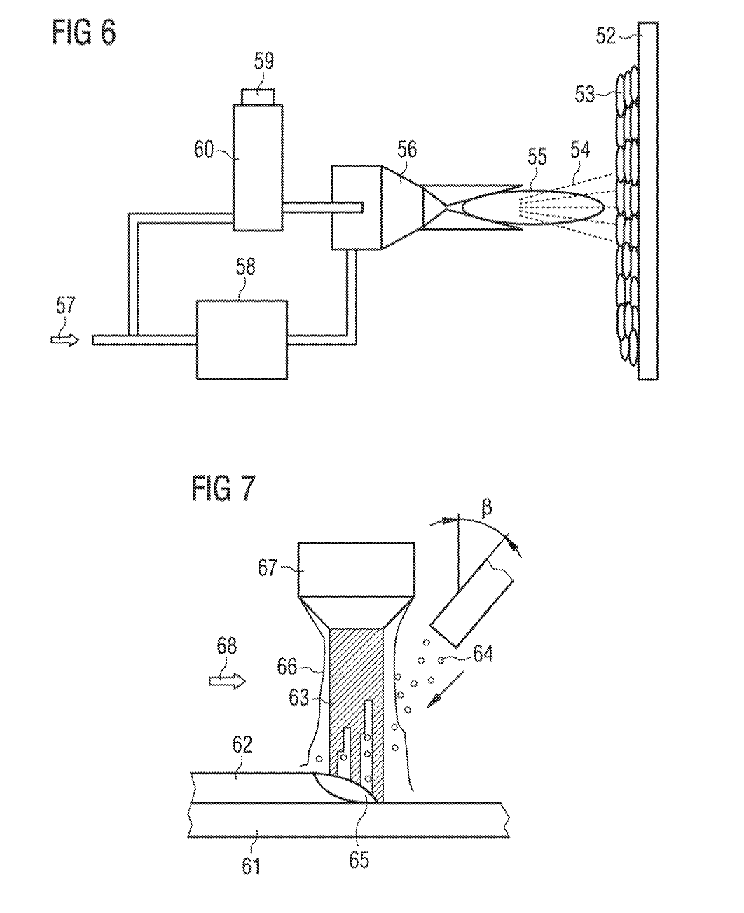

FIG. 6 schematically shows a cold spray process. Particles 54 are sprayed by means of a gas jet 55 onto a surface of a substrate 52 forming a coating 53. A gun 56 used for spraying is connected to a high pressure working gas supply 57, a gas heater 58 for heating the high pressure working gas, a powder hopper 59 and a carrier heater 60.

Cold spray of materials involves a high velocity deposition of materials with thickness build up as a consequence of local thermo-mechanical bonding. Based on mass conservation and the spray profile build up characteristics, the deposition process can be modeled for material thickness.

FIG. 7 schematically shows a powder injection into a laser. A laser beam 63 of a laser 67 is rectangular directed onto a surface of a substrate 61. A powder jet 64 is injected into the laser beam 63 at an angle β. When the laser beam 63 with the powder reaches the surface of the substrate 61 the powder particles melt or are still molten and a melting zone 65 occurs. The laser beam 63 is surrounded by a shield gas 66. The surface of the substrate 61 is scanned by the laser beam 63 in scanning direction 68.

Each of the processes shown in FIGS. 2 to 7 can be simulated using the mass conservation principles. These simulations can be applied for a wide variety of deposition processes.

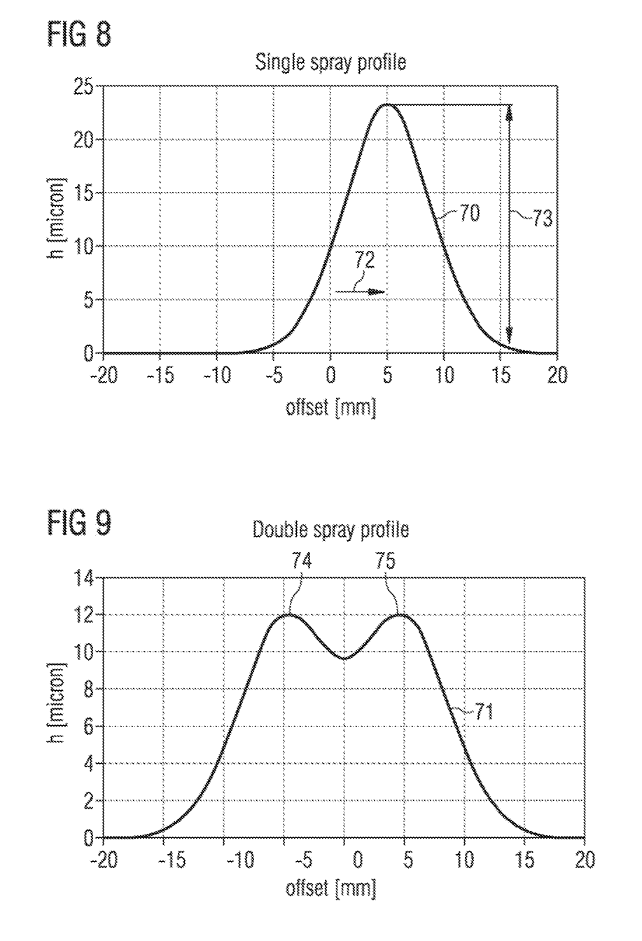

FIG. 8 schematically shows a single spray profile 70. FIG. 9 schematically shows a double spray profile 71. In both figures the x-axis shows the offset in mm and the y-axis shows the hight h in micron. In FIG. 8 the single spray profile 70 shows an offset 72 of 5 mm and a maximum height 73 of 23 micron. In FIG. 9 the double spray profile 71 shows two peaks, the first peak 74 at an offset of −5 mm and the second peak 75 at an offset of 5 mm Both peaks 74 and 75 have a height of 12 micron.

Based on the input of the 3D CAD model of a gas turbine component, simulation of the deposition path and coating thickness buildup has been successfully demonstrated for coating deposition on gas turbine components.

Moreover, based on the interaction heat build up of transferred powder particles and local tip shape, a simulation of the tip build up can be developed using laser powder melting.

Concerning sensor deposition on to gas turbine components deposition of thermocouples and strain gauges by thermal spray processes, either directly or by masking, is very well demonstrated. Depending upon the routing of the instrumentation path on the gas turbine surface, a simulation model can be developed to meet the thickness and width requires of sensor deposition.

Ink-jet printing of sensors is also demonstrated in the industry. This also requires a transfer of material through a “suspension ink”, which upon deposition is available to function as a sensor.

Standard commercial software available for paint buildup, especially for automotive and other industries, also use empirical fits to the paint spray profile. Mass conservation principles will enable a better optimization of the paint thickness deposition and also deposition efficiencies.

Generally, the inventive method is aapplicable to a wide range of materials buildup and deposition processes, since a model formula for the spray profile is created. The model formula is based on a physical model of the thermal spray process and empirical input from a reference experiment. The created model formula can be used as input for computation, for example for a coating thickness computation with Robcad/Paint software package. Compared with the mentioned state of the art, where a recalculation of approximation coefficients is needed after any change in process, where the asymmetry of the spray spot can not be described and a poor accuracy as achieved, the inventive method needs only one reference test, is applicable for a broad process parameter range, can automatically implement a variation of process parameters and provides a good simulation accuracy.

Thickness profile prediction on a substrate (or component), described by a CAD model, also enables an automatic modification of the robotic path when the substrate (or component) geometry changes. Automatic path generation with the specific spray profile on a complex surface can utilize the precise description of the spray profile to predict coating thickness on new geometries.

1-14. (canceled)

15. A method for simulating of the thickness of a coating which is placed onto a substrate surface, comprising:
simulating the thickness using mass conservation principles; and
coating the substrate surface by atmospheric plasma spraying, high velocity oxygen fuel spraying, low pressure plasma spraying, thermal spray coating deposition, laser cladding, wire arc spraying, cold spraying or sensor deposition.

16. The method as claimed in claim 15, wherein the coating is sprayed onto the substrate surface.

17. The method as claimed in claim 15, wherein the coating is sprayed onto a gas turbine component.

18. The method as claimed in claim 15, wherein an incoming powder jet is simulated as a conical fan expanding with distance from a nozzle.

19. The method as claimed in claim 15, wherein the thickness is simulated using mass conservation laws inside a powder jet accelerated from a nozzle to the substrate surface.

20. The method as claimed in claim 16,
wherein a reference spray trial is performed,
wherein the correlation of a single spray profile to a spray process parameter is determined, and
wherein the single spray profile is simulated using mass conservation principles to an incoming powder jet stream.

21. The method as claimed in claim 15, wherein the correlation of a single spray profile to a deposition variable is determined.

22. The method as claimed in 21, wherein the deposition variable is selected from the group consisting of a powder feed rate, a flux density, a distance between a spray gun and the substrate surface, a spray gun speed, a spray angle, a spray efficiency, a thickness standard deviation, a standard deviation of flux density, a standard deviation of the thickness distribution of the single spray profile, a coating density, a displacement of the single spray profile from a tool central point, and a combination thereof.

23. The method as claimed in claim 15, wherein an efficiency factor, the dependence of an efficiency factor on a spray angle, the dependence of a standard deviation on a spray distance, and the dependence of a standard deviation on a spray gun tilting angle are determined.

24. The method as claimed in claim 15, wherein an efficiency factor is determined.

25. The method as claimed in claim 15, wherein the dependence of an efficiency factor on a spray angle is determined.

26. The method as claimed in claim 15, wherein the dependence of a standard deviation on a spray distance is determined.

27. The method as claimed in claim 15, wherein the dependence of a standard deviation on a spray gun tilting angle is determined.

28. The method as claimed in claim 15, wherein the normal component distribution of a power speed of a powder jet, the normal component distribution of a power density of a powder jet, and the normal component distribution of a resulting mass flux density of a powder jet are considered to fit Gaussian law in any cross section of the powder jet.

29. The method as claimed in claim 15, wherein the normal component distribution of a power speed of a powder jet, or the normal component distribution of a power density of a powder jet, or the normal component distribution of a resulting mass flux density of a powder jet is considered to fit Gaussian law in any cross section of the powder jet.

30. The method as claimed in claim 15,
wherein a single spray profile thickness distribution is considered to have a Gaussian distribution in the direction perpendicular to a substrate cross section, and
wherein a single spray profile thickness distribution is considered to have an elliptical form in the projection onto the substrate surface.

31. The method as claimed in claim 15, wherein a single spray profile thickness distribution is considered to have a Gaussian distribution in the direction perpendicular to a substrate cross section or to have an elliptical form in the projection onto the substrate surface.

32. The method as claimed in claim 15, wherein a spray profile from a multiply injector spraying is represented as a sum of a corresponding number of single spray profiles.

33. The method as claimed in claim 15, wherein the coating thickness is calculated analytically for a given coating pattern.
